(19) United States
(12) Patent Application Publication
(10) Pub. No.: US 2025/0112757 A1
(43) Pub. Date: Apr. 3, 2025

(54) TECHNIQUES FOR USE OF MIXED WORD SIZE MULTIPLICATION FOR FULLY HOMOMORPHIC ENCRYPTION RELINEARIZATION

(71) Applicant: Intel Corporation, Santa Clara, CA (US)

(72) Inventors: Raghavan KUMAR, Hillsboro, OR (US); Sanu K. MATHEW, Portland, OR (US); Adish VARTAK, Palo Alto, CA (US); Christopher B. WILKERSON, Vancouver, WA (US)

(73) Assignee: Intel Corporation, Santa Clara, CA (US)

(21) Appl. No.: 18/374,179

(22) Filed: Sep. 28, 2023

(51) Int. Cl. H04L 9/00; H04L 9/06

(52) U.S. Cl. CPC H04L 9/008; H04L 9/0618

(57) ABSTRACT

Examples include techniques for mixed word size multiplication to facilitate operations for relinearization associated with executing a fully homomorphic encryption (FHE) workload. Examples include use of precomputed base conversion factors and decomposing large words or digits to a data size that is equal to or smaller than a machine word size associated with a multiplier datapath to facilitate the operations for relinearization.

### STATEMENT REGARDING FEDERALLY SPONSORED RESEARCH

This invention was made with Government support under contract number HR0011-21-3-0003-0104 awarded by the Department of Defense. The Government has certain rights in this invention.

### TECHNICAL FIELD

Examples described herein are generally related to techniques associated with use of mixed word size multiplication for fully homomorphic encryption to facilitate efficient relinearization.

### BACKGROUND

Homomorphic encryption is a form of encryption that allows computations to be performed on encrypted data without first having to decrypt it. The computations are performed on polynomials. The degree of a polynomial is the highest of the degrees of the polynomial's individual terms with non-zero coefficients. The degree of a term is the sum of the exponents of the variables in the term. The degree of the polynomial is the highest exponent in the polynomial. For example, the polynomial 5x2y4+3x−10 has three terms, two variables (x, y) and two coefficients (number that is being multiplied by a variable). The first term has a degree of 6 (the sum of exponent 2 and exponent 4), the second term has a degree of 1 and the third term has a degree of 0. The polynomial has a degree of 6 (the highest exponent of the terms in the polynomial).

Fully Homomorphic Encryption (FHE) enables computation on encrypted data, or ciphertext, rather than plaintext, or unencrypted data, keeping data protected at all times. FHE uses lattice cryptography, which presents complex mathematical challenges to would-be attackers. FHE standards support a wide range of polynomials, with the degree of the polynomial ranging from 1024 (1K-degree) to a 128K-degree polynomial and where each coefficient in the polynomial can range from 32 bits to 2K bits dependent on the degree of the polynomial.

### BRIEF DESCRIPTION OF THE DRAWINGS

FIG. 1 illustrates an example system.

FIG. 2 illustrates an FHE Scheme.

FIG. 3 illustrates examples first logic flow.

FIG. 4 illustrates an example operation for base conversion.

FIG. 5 illustrates an example operation.

FIG. 6 illustrates an example multiplication scheme.

FIG. 7 illustrates an example apparatus.

FIG. 8 illustrates an example second logic flow.

FIG. 9 illustrates an example computing system.

FIG. 10 illustrates a block diagram of an example processor and/or System on a Chip (SoC) that may have one or more cores and an integrated memory controller.

### DETAILED DESCRIPTION

Relinearization can be a critical operation associated with homomorphic encryption (HE) workloads and can often constitute/consume as much as 90% of workload cycles. State-of-the-art relinearization algorithms adopt a hybrid or large-word decomposition technique, to minimize the size of relinearization keys and reduce latency associated with relinearization operations. However, large-word decomposition technique can include the multiplication of machine word-size operands with larger word-size operands (>128 bits). The larger word-size operands do not natively fit on a datapath designed for machine word-size operations that are typically 32 bits in multiplier circuitry included in fully homomorphic encryption (FHE) accelerators arranged to execute FHE workloads. One solution to a larger word-size operands not natively fitting a datapath size for FHE accelerators is to increase the datapath size via adoption of larger word-size multipliers (e.g., 64, 128 or 256 bits) in FHE accelerators. Another solution is to perform a serial multiplication on mixed word-size operands. For example, mixed word-size operands of 32 bits and 128 bits can be broken down into 4 32×32 bit multiplications, with the carry information propagated down the partial products for accurate computation of outputs.

In some examples, solutions can include building a large word-size multiplier (for example 128-bit multiplier) into an FHE accelerator to provide native support to map a 32×128b multiplication associated with mixed word-size operands. However, a 128-bit multiplier can occupy a physical space on an FHE accelerator that can be 16 times larger than a physical space occupied by a 32-bit multiplier. The relatively large physical space needed for a 128-bit multiplier can result in a significant loss of area-efficiency for iso-area compared to a 32-bit multiplier. Also, a 32×128 bit multiplication can result in a 4× reduction in multiplier utilization during a relinearization operation.

According to some examples, a solution that includes use of serial multiplication on mixed word-size operands may involve implementation of a serial multiplication method. As mentioned briefly above, serial multiplication can include breaking down mixed word-size operands of 32 bits and 128 bits to 4 32×32 bit multiplications. Conventional FHE accelerators can include a polynomial multiplication in an instruction set architecture (ISA), which operates on one of the residues of a polynomial. For these examples, 4 serial multiplications can be implemented using 4 ISA instances for polynomial multiplication. However, carry propagation resulting from partial product accumulation requires the carry information to be propagated across the 4 ISA instances or instruction calls. Propagating the carry information across 4 ISA instruction calls can result in a sub-optimal usage of a residue number system (RNS).

As described in more detail below, a mixed word-size Montgomery multiplier approach is described that provides support for arbitrary word-size multiplications on a fixed machine word-size multiplier (e.g., 32 bits). Operands such as base conversion factors that are multiplied with larger word sizes in a relinearization operation can depend on an underlying ciphertext modulus. As such, these base conversion factors can be defined a priori, independent of ciphertext data. This independence can allow for base conversion factors to be decomposed further into the residue domain as a precomputed value and then streamed into an FHE accelerator as metadata. Decomposition into the RNS domain enables the arbitrary word-size multiplications to be purely carried out on a 32 bit datapath of the FHE accelerator, with no carry propagation across the residues of a polynomial associated with the relinearization operation.

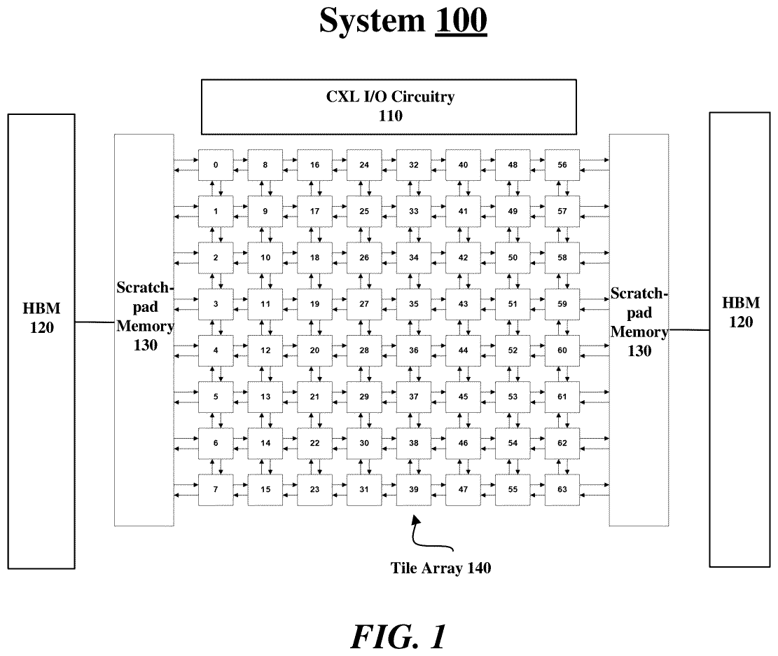

FIG. 1 illustrates an example system 100. In some examples, system 100 can be included in and/or operate within a compute platform. The compute platform, for example, could be located in a data center included in, for example, cloud computing infrastructure, examples are not limited to system 100 included in a compute platform located in a data center. As shown in FIG. 1, system 100 includes compute express link (CXL) input/output (I/O) circuitry 110, high bandwidth memory (HBM) 120, scratchpad memory 130 or tile array 140.

In some examples, system 100 can be configured as a parallel processing device or accelerator to perform computations (e.g., number-theoretic-transforms (NTT) and inverse-NTT (iNTT) operations) for accelerating FHE workloads. For these examples, CXL I/O circuitry 110 can be configured to couple with one or more host central processing units (CPUs—not shown) to receive instructions and/or data via circuitry designed to operate in compliance with one or more CXL specifications published by the CXL Consortium to included, but not limited to, CXL Specification, Rev. 2.0, Ver. 1.0, published Oct. 26, 2020, or CXL Specification, Rev. 3.0, Ver. 1.0, published Aug. 1, 2022. Also, CXL I/O circuitry 110 can be configured to enable one or more host CPUs to obtain data associated with execution of accelerated FHE workloads by compute elements included in interconnected tiles of tile array 140. For example, data (e.g., ciphertext or processed ciphertext) may be received to or pulled from HBM 120 and CXL I/O circuitry 110 can facilitate the data movement into or out of HBM 120 as part of execution of accelerated FHE workloads. Also, scratchpad memory 130 can be a type of memory (e.g., register files) that can be proportionately allocated to tiles included in tile array 140 to facilitate execution of the accelerated FHE workloads.

In some examples, tile array 140 can be arranged in an 8×8 tile configuration as shown in FIG. 1 that includes tiles 0 to 63. For these examples, each tile can include, but is not limited to, 128 compute elements (not shown in FIG. 1) and local memory (e.g., register files) to store the input operands and results of operations/computations. The 128 compute elements can be 128 separately reconfigurable butterfly circuits, that are configured to compute output terms associated with polynomial coefficients (e.g., for NTT/iNTT operations/computations). As shown in FIG. 1, tiles 0 to 63 can be interconnected via point-to-point connections via a 2-dimensional (2D) mesh interconnect-based architecture. The 2D mesh enables communications between adjacent tiles using single-hop links, as one example of an interconnect-based architecture, examples are not limited to 2D mesh.

According to some examples, at least some compute elements included in tiles 0 to 63 of tile array 140 can include fixed machine word-size multipliers (e.g., 32 bits) to be used for arbitrary word-size multiplications associated with relinearization operations. As described in more detail below, the relinearization operations can include multiplying precomputed RNS decomposed large word-size operands in a Mongomery form with larger word sizes using fixed machine word-size multipliers. The precomputed RNS decomposed large word-size operands can be streamed to the compute elements of tiles 0 to 63 of tile array 140 (e.g., through CXL I/O circuitry 110) as part of a setup phase to program system 100 for executing FHE workloads.

Examples are not limited to use of CXL I/O circuitry such as CXL I/O circuitry 110 to facilitate receiving instructions and/or data or providing executed results associated with FHE workloads. Other types of I/O circuitry and/or additional circuitry to receive instructions and/or data (e.g., precomputed base conversion factors) or provide executed results are contemplated. For example, the other types of I/O circuitry can support protocols associated with communication links such as Infinity Fabric® I/O links configured for use, for example, by AMD® processors and/or accelerators or NVLink™ I/O links configured to use, for example, by Nvidia® processors and/or accelerators.

Examples are not limited to HBM such as HBM 120 for receiving data to be processed or to store information associated with instructions to execute an FHE workload, execution results of the FHE workload or associated with FHE workload related operations such as those related to relinearization operations. Other types of volatile memory or non-volatile memory are contemplated for use in system 100. Other type of volatile memory can include, but are not limited to, Dynamic RAM (DRAM), DDR synchronous dynamic RAM (DDR SDRAM), GDDR, static random-access memory (SRAM), thyristor RAM (T-RAM) or zero-capacitor RAM (Z-RAM). Non-volatile types of memory can include byte or block addressable types of non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

According to some examples, system 100 can be included in a system-on-a-chip (SoC). An SoC is a term often used to describe a device or system having compute elements and associated circuitry (e.g., I/O circuitry, butterfly circuits, power delivery circuitry, memory controller circuitry, memory circuitry, etc.) integrated monolithically into a single integrated circuit (“IC”) die, or chip. For example, a device, computing platform or computing system could have one or more compute elements (e.g., butterfly circuits) and associated circuitry (e.g., I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

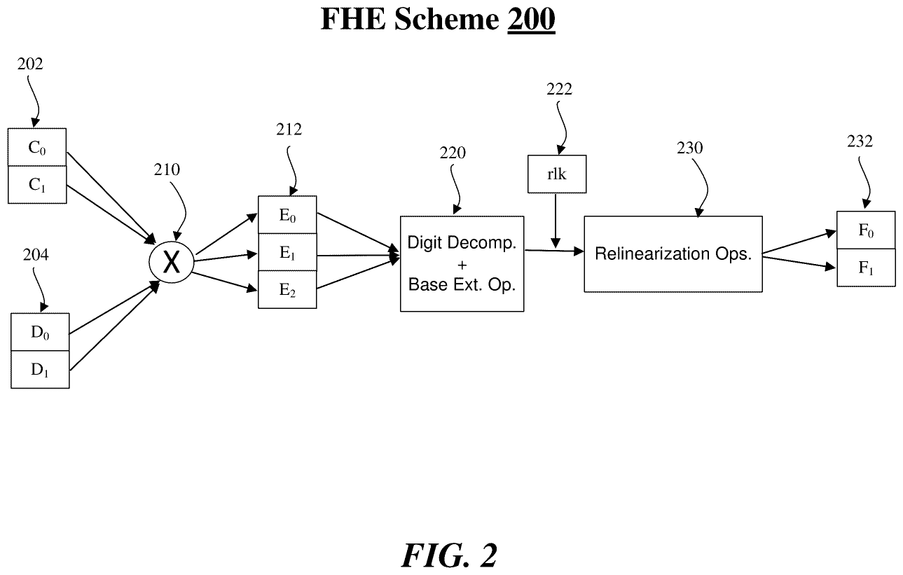

FIG. 2 illustrates an example FHE scheme 200. According to some examples, as shown in FIG. 2, a multiplier 210 can perform a homomorphic multiplication on a first 2-term ciphertext 202 [C₀, C₁] and a second 2-term ciphertext 204 [D₀, D₁] to result in a 3-term ciphertext 212 [E₀, E₁, E₂]. In an example 16K degree polynomial FHE scheme, each polynomial has a data size of 1 megabyte (MB). Hence, back-to-back FHE multiplications can result in FHE ciphertexts of increasingly large sizes that can result in a significant data size explosion. Multiplier 210, for example, can be included in an accelerator arranged to execute FHE workloads such as system 100 shown in FIG. 1 and described above.

According to some examples, relinearization techniques can enable a mapping of 3 or larger term size ciphertext to a 2-term ciphertext. For example, as shown in FIG. 2, relinearization operations 230 may include relinearization techniques to map 3-term ciphertext 212 to a 2-term ciphertext 232 [F₀, F₁], which decrypts to a same value. The 3-term ciphertext 212 can be decrypted using a secret key vector [l, s, s²] (not shown). Relinearization techniques included in relinearization operations 230 can aim, for example, to compute a product of E₂ included in 3-term ciphertext 212 and s² included in the secret key vector. However, as a secret key (or its powers) cannot be publicly revealed in plaintext form, an encrypted version of s² is published publicly, and is referred to as a relinearization key (rlk). For example, as part of FHE scheme 200, an rlk 222 is shown as being provided for use in relinearization operations 230 to map 3-term ciphertext 212 to 2-term ciphertext 232. Rlk 222 can be precomputed, prior to an FHE workload execution.

Relinearization keys can typically be large data size operands and these large data size operands can consume anywhere between tens to hundreds of MBs depending on a polynomial size used for FHE workloads. However, as described in more detail below, techniques such as techniques included in a digit decomposition+base extension operation 220 can be implemented to cause a reduction in a data size for a relinearization key such as rlk 222 to be used in relinearization operations such as relinearization operations 230. For example, digit decomposition+base extension operation 220 can include large-digit or hybrid decomposition based relinearization that aims to reduce the data size of rlk 222 by decomposing ciphertext included in 3-term ciphertext 212 (e.g., E₂) and decomposing precomputed base conversion factors into large size words, followed by a dot product operation with rlk 222. For this example, large size words can minimize or reduce a number of entries of a key operand vector, resulting in a reduction of data size for rlk 222. For example, compared to a conventional RNS-32 decomposition, a large size word or large digit decomposition to 4 digits of 32 bits each can reduce a data size of rlk 222 by as much as 13× for a polynomial size of 64K or around 3.4× for a polynomial size of 16K.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

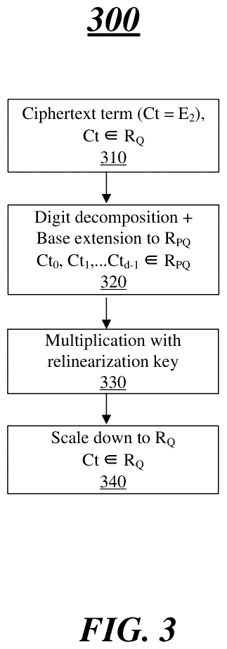

FIG. 3 illustrates an example logic flow 300. According to some examples, logic flow 300 can represent an overview of a large digit or hybrid decomposition such as mentioned above for FHE scheme 200. For these examples, at 310, an example ciphertext term of Ct=E₂ is selected for decomposition. For these examples, E₂ can be a large word or digit ciphertext such as, but not limited to, 128-bit large digit word. Also, ciphertext term Ct is shown at block 310 as belonging to a polynomial ring R_{Q}. Polynomial ring R_{Q}, for example, can belong to an RNS domain.

In some examples, at 320, ciphertext term Ct is decomposed to large radix words, where “d” represents a number of words via which Ct is decomposed. For example, if coefficients of Ct are 128 bits, then Ct can be decomposed into 4 32-bit large radix words and for this example d=4. In order to accommodate for noise growth from large words, resulting ciphertext residues can be extended to basis R_{PQ}.

According to some examples, at 330, a relinearization key (computed a priori) in basis R_{PQ} is multiplied with the decomposed ciphertext. The multiplication, for example, to be carried out by or mapped to a 32 bit multiplier included in a datapath of an FHE accelerator arranged to execute FHE workloads. In other words, mapped to a machine word-size multiplier of 32 bits.

In some examples, at 340, the multiplied outputs from the multiplication at block 330 can be converted back to basis R_{Q} for subsequent FHE computations. Logic flow 300 then comes to an end.

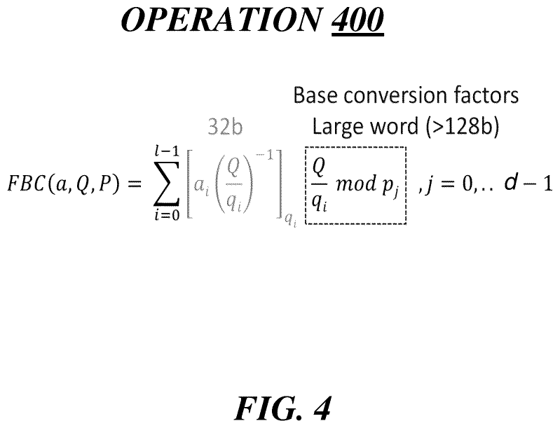

FIG. 4 illustrates an example operation 400. According to some examples, while operations mentioned above for logic flow 300 can map to machine word-size multipliers (e.g., 32 bits), a base extension operation that requires conversions between residue or RNS (basis Q) and RNS/positional (basis P) number domains is needed. For a 32 bit residue word example, conversions between RNS and RNS/positional number domains further requires 32 bit residue words with a large coefficient (e.g., >128 bits depending on the number of decomposed words (d)).

Operation 400 in FIG. 4 shows an example of a fast base conversion (FBC). According to some examples, residue words/coefficients of an FHE polynomial “ai” are 32 bit machine size words. However, during an FBC process, the residue words/coefficients can be multiplied with base conversion factors that can also be a large word (e.g., >128 bits) for conversion from the residue or RNS number domain to an RNS/positional number domain. Base conversion factors, as shown in FIG. 4, can be purely a function of ciphertext residue moduli values (Q, qᵢ) and do not depend on ciphertext terms and/or residual words of ciphertext “aᵢ”. As a result of being purely a function of ciphertext residue moduli values (Q, qᵢ), the base conversion factors can be precomputed, independent of data dependent workload inputs (e.g., ciphertext) during setup or programming of an FHE scheme to an FHE accelerator.

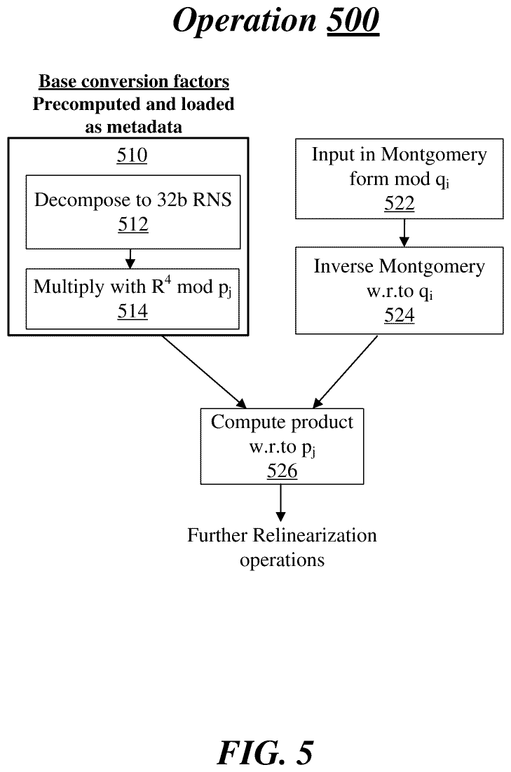

FIG. 5 illustrates an example operation 500. According to some examples, operation 500 can depict how a mixed word size multiplier operation can leverage an independent nature of base conversion factors. For example, at 510, base conversion factors are precomputed and loaded as metadata to an accelerator arranged to execute FHE workloads that include relinearization operations (e.g., loaded to system 100). Precomputation can include, at 512, decomposing base conversion factors into 32 bit residues in the RNS/residue domain such that the decomposed base conversion factors can natively fit into a 32 bit multiplier datapath in the FHE accelerator similar to what is mentioned above for operation 400. For example operation 500, Montgomery multipliers are used in the accelerator to simplify modular reduction operations. Based on a Montgomery representation for an input operand of a decomposed ciphertext word into 4 32 bit large radix words, at 514, precomputation can also include multiplication of the decomposed base conversion factors with R⁴ mod pⱼ. This multiplication, at 514, is based on the Montgomery representation for the input operand “a” being a*R² mod q, where R=2¹⁶ (for 32-bit multipliers) and is also based on absorbing the factor R² into the precomputed values of the decomposed base conversion factors to arrive at R⁴ mod pⱼ. The absorbing of factor R² allows for an implicit forward conversion from modulus qᵢ to pᵢ for precomputed values of the decomposed base conversion factors.

In some examples, as mentioned previously, an input operand a of the decomposed ciphertext word is in a Montgomery representation that is a*R² mod q. Therefore, at 522, the input in Montgomery form mod q shows that data dependent residues are represented in basis q. Then, at 524, the input in Montgomery form mod qᵢ that has data dependent residues in Montgomery domain Q is converted to Montgomery domain P by performing an inverse Montgomery operation with regard (w.r.) to qᵢ, followed by a Montgomery conversion to basis P.

Operation 500, at 526, computes a product w.r. to pⱼ (j=0, . . . , d−1) using the precomputed base conversion factors from 514 of operation 500 with the inverse Montgomery form mod qᵢ. The Montgomery conversion to basis P for data dependent residues in the inverse Montgomery form can be implicitly performed based on the absorbing of factor R² for the precomputed values of the decomposed base conversion factors from 514. In other words, an inverse Montgomery computation w.r. to qᵢ for the data dependent residues is performed by circuitry at the FHE accelerator but this circuitry is not used or needed for the Montgomery conversion to basis P. The conversion from basis Q (RNS domain) to basis P (RNS/positional number domain) for the data dependent residues in inverse Montgomery form can help to avoid l*k additional polynomial multiplications (where l is a number of terms in basis Q and k is a number terms in basis P). The computed product from 526 of operation 500 is then used for further relinearization operations. The computed product, for example, enables use of decomposed large size words in a multiplier datapath of an accelerator that is comparatively smaller that the pre-decomposed large size words to enable a reduction or minimization of a data size of relinearization keys used in relinearization operations.

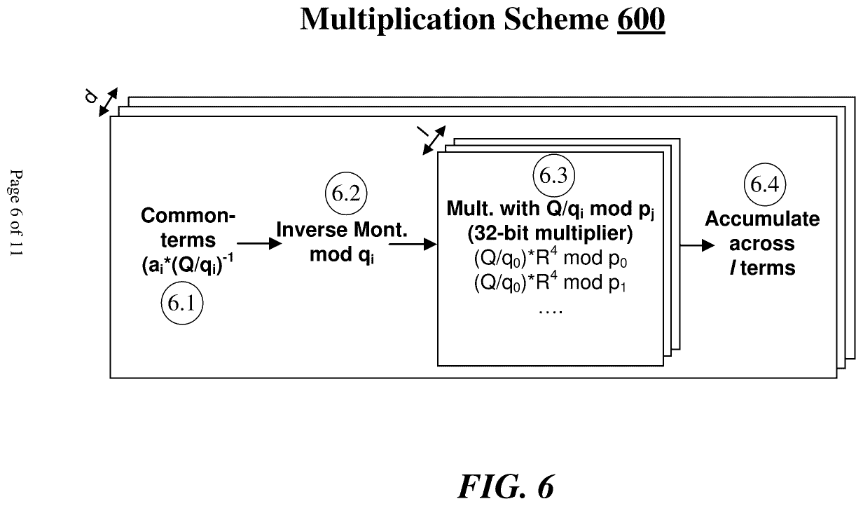

FIG. 6 illustrates an example multiplication scheme 600. In some examples, multiplication scheme 600 can represent a sequence of operations for each decomposed large word or large digit d to compute a product using a machine word size datapath that is smaller than the large word or large digit of an input operand. For example, the machine word size datapath can be 32 bits and the large word or large digit of the input operand can be 128 bits.

According to some examples, at operation 6.1, common terms (aᵢ*Q/qᵢ)⁻¹ can represent respective residue words/coefficients of an input operand that is an FHE polynomial ai. For these examples, aᵢ can be decomposed to fit in a 32 bit datapath. In other words, the residue words are part of a ciphertext term to be decomposed to large radix words or digits of 32 bits each. The common terms, for example, input in Montgomery form mod qᵢ that have data dependent residues in Montgomery domain Q are similar to what was mentioned above for operation 500 at 514. For these examples, the FHE polynomial can be a 64K polynomial and “i” can represent a respective 32 bit large radix word or digit, where i=0, 1, . . . d−1.

In some examples, at operation 6.2, an inverse Montgomery operation is performed on the 32 bit common terms with regards to mod qᵢ, similar to what was mentioned above for operation 500 at 516. For these examples, the respective 32 bit large radix word or digit is used for the inverse Montgomery operation.

According to some examples, at operation 6.3, the result of the inverse Montgomery operation on the 32 bit common terms is multiplied with precomputed base conversion factors that is depicted in FIG. 6 as “mult. with Q/qᵢ mod pⱼ (32-bit mult) (Q/q₀)*R⁴ mod p₀, (Q/q₀)*R⁴ mod p₁ . . . ”. For these example, q₀ is associated with a first large radix word of 32 bits used in the multiplication with the precomputed base conversion factors. Also, the incrementing of p₀ to p₁ indicates respective decomposed portions of the precomputed base conversion factors to fit in a 32 bit data path. For example, if decomposed from 128 bits to 32 bits, “j” in pⱼ would be j=0, . . . , d−1 and a total of 4 32 bit multiplications would occur to complete operation 6.3 for q₀.

In some examples, at operation 6.4, the 4 32 bit multiplications completed in operation 6.3 are accumulated across l terms or residues. As mentioned above, the FHE polynomial can be a 64K polynomial. A 64K polynomial can have 64 terms or residues. Therefore, l=64 and the 4 32 bit multiplications are accumulated across 64 terms to compute a product.

A same sequence of operations 6.1 to 6.4 are implemented for the remaining 3 large words or large digits to compute respective products for these other 3 large words or large digits. Multiplication scheme 600 then comes to an end.

Products generated via multiplication scheme 600, for example, can be used in additional multiplications with a relinearization key that can now be of a reduced size for the reasons mentioned above.

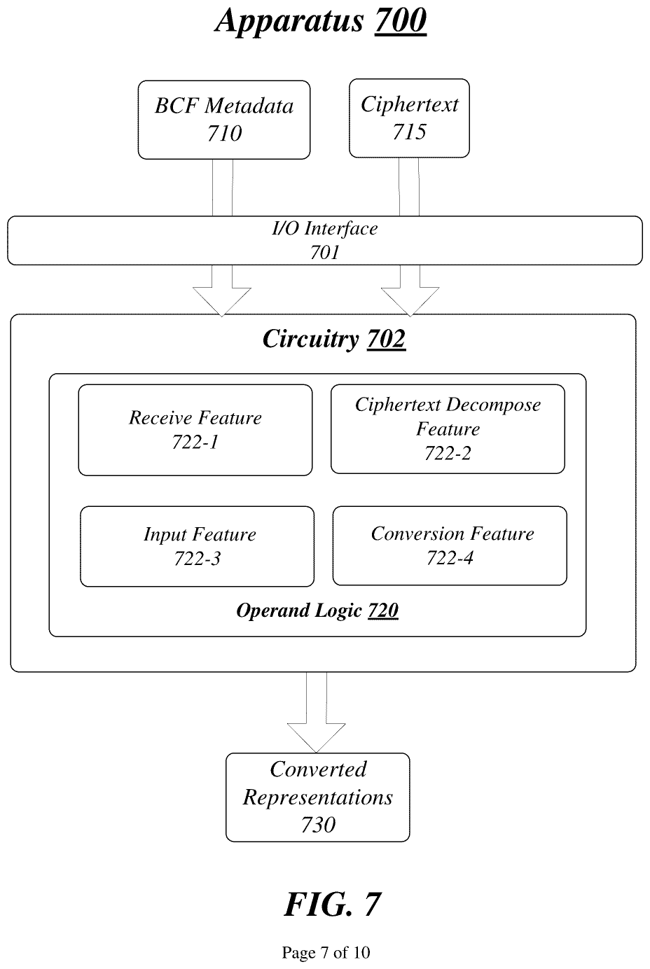

FIG. 7 illustrates an example block diagram for apparatus 700. Although apparatus 700 is shown in FIG. 7 has a limited number of elements in a certain topology, it can be appreciated that apparatus 700 can include more or less elements in alternate topologies as desired for a given implementation.

In some examples, apparatus 700 may be included on a same chip or die as an accelerator such as an accelerator included in system 100 shown in FIG. 1. As shown in FIG. 7, apparatus 700 includes an I/O interface 701. For these examples, I/O interface 701 can be similar, in at least some aspects, to CXL I/O circuitry 110 of system 100 and can be arranged to receive or obtain data associated with, but not limited to, precomputed base conversion factors or ciphertext terms included or associated with FHE workloads to be executed by the accelerator.

According to some examples, apparatus 700 can be supported by circuitry 702. For these examples, circuitry 702 can be at an application specific integrated circuitry (ASIC), field programmable gate array (FPGA), configurable logic, processor circuitry located on or with the accelerator arranged to execute and/or support FHE workloads. For these examples, the ASIC, FPGA, configurable logic, processor circuitry can support logic and/or features of an operand logic 720 arranged to allow for use of large word or large digit sizes as operands to be used in relinearization operations associated with FHE workloads. Circuitry 702 can execute operand logic 720 and operand logic 720 can be arranged to implement one or more software or firmware implemented modules, components, or features 722-a (module, component, logic or feature can be used interchangeably in this context). It is worthy to note that “a” and “b” and “c” and similar designators as used herein are intended to be variables representing any positive integer. Thus, for example, if an implementation sets a value for a=4, then a complete set of software or firmware for modules, components or features 722-a can include features 722-1 to 722-4. The examples presented are not limited in this context and the different variables used throughout can represent the same or different integer values. Also, “logic”, “module”, “component” or “feature” can also include software/firmware stored in computer-readable media, and although types of logic or features are shown in FIG. 7 as discrete boxes, this does not limit these types of logic or features to storage in distinct computer-readable media components (e.g., a separate memory, etc.).

According to some examples, operand logic 720 can include a receive feature 722-1. Receive feature 722-1 can receive, through I/O interface 701, a ciphertext term, the ciphertext term to have a data size larger than a machine word size associated with a multiplier datapath of the accelerator configured to execute the FHE workload associated with the ciphertext term. For these examples, ciphertext 715 can include the ciphertext term received through I/O interface 701.

In some examples, operand logic 720 can include a ciphertext decompose feature 722-2. Ciphertext decompose feature 722-2 can decompose the ciphertext term to a plurality of words such that each word has a data size equal to or smaller than the machine word size. For example, the machine word size is 32 bits and the ciphertext term is decomposed to words of a data size of no larger than 32 bits.

According to some examples, operand logic 720 can include an input feature 722-3. Input feature 722-3 can cause the plurality of words to be input in the multiplier datapath as separate Montgomery representations in order to compute separate inverse Montgomery representations for each of the plurality of words.

In some examples, operand logic 720 can include a conversion feature 722-4. Conversion feature 722-4 can receive or obtain, through the I/O interface, precomputed base conversion factors that were precomputed independent of data included in the ciphertext term, the precomputed base conversion factors to also have been decomposed to have a data size equal to or smaller than the machine word size. For these examples, the precomputed base conversions can be included in BCF metadata 710 that could have been stored to a memory on the same chip or die as circuitry 702 and the accelerator at the time the accelerator was programmed to execute the FHE workload. Conversion feature 722-4 can also cause each of the separate inverse Montgomery representations to be multiplied with the precomputed base conversion factors. The multiplication with the precomputed base conversion factors can be to convert the separate inverse Montgomery representations from an RNS domain to an RNS/positional number domain. For these examples, the converted separate inverse Montgomery representation can then be provided via converted representations 730 for use in a relinearization operation associated with the ciphertext term.

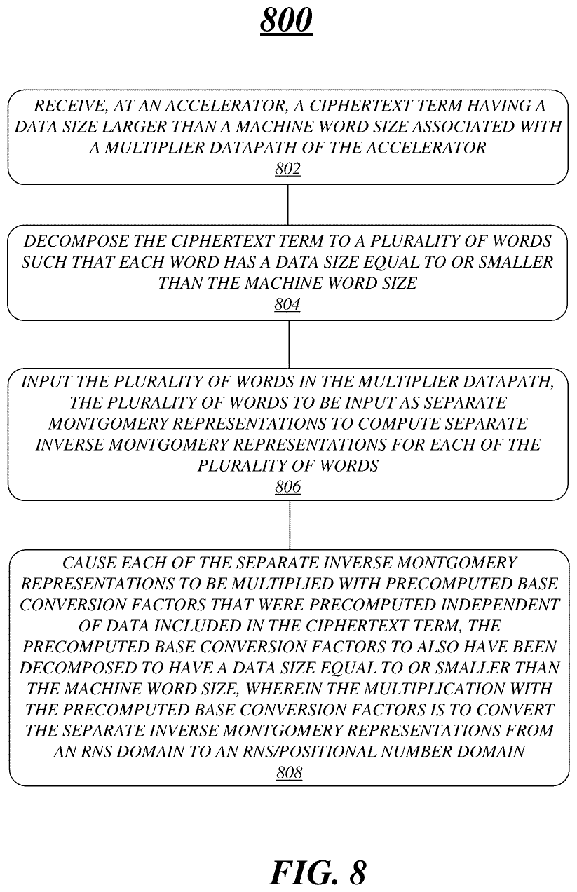

FIG. 8 illustrates an example logic flow 800. Logic flow 800 can be representative of some or all of the operations executed by one or more logic, features, or devices described herein, such as apparatus 700. More particularly, logic flow 800 can be implemented by at least receive feature 722-1, ciphertext feature 722-2, input feature 722-3, or conversion feature 722-4.

In some examples, logic flow 800 at block 802 can receive, at an accelerator, a ciphertext term having a data size larger than a machine word size associated with a multiplier datapath of the accelerator. For these examples, receive feature 722-1 can receive the ciphertext term.

According to some examples, logic flow 800 at 804 can decompose the ciphertext term to a plurality of words such that each word has a data size equal to or smaller than the machine word size. For these examples, ciphertext decompose feature 722-2 can decompose the ciphertext term.

In some examples, logic flow 800 at 806 can input the plurality of words in the multiplier datapath, the plurality of words to be input as separate Montgomery representations to compute separate inverse Montgomery representations for each of the plurality of words. For these examples, input feature 722-3 can input the plurality of words in the multiplier datapath.

According to some examples, logic flow 800 at 808 can cause each of the separate inverse Montgomery representations to be multiplied with precomputed base conversion factors that were precomputed independent of data included in the ciphertext term, the precomputed base conversion factors to also have been decomposed to have a data size equal to or smaller than the machine word size, wherein the multiplication with the precomputed base conversion factors is to convert the separate inverse Montgomery representations from an RNS domain to an RNS/positional number domain. For these examples, conversion feature 722-4 can cause the conversion of each of the separate inverse Montgomery representations from the RNS domain to the RNS/positional number domain.

The logic flow shown in FIG. 8 can be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a software or logic flow can be implemented by computer executable instructions stored on at least one non-transitory computer readable medium or machine readable medium, such as an optical, magnetic or semiconductor storage. The embodiments are not limited in this context.

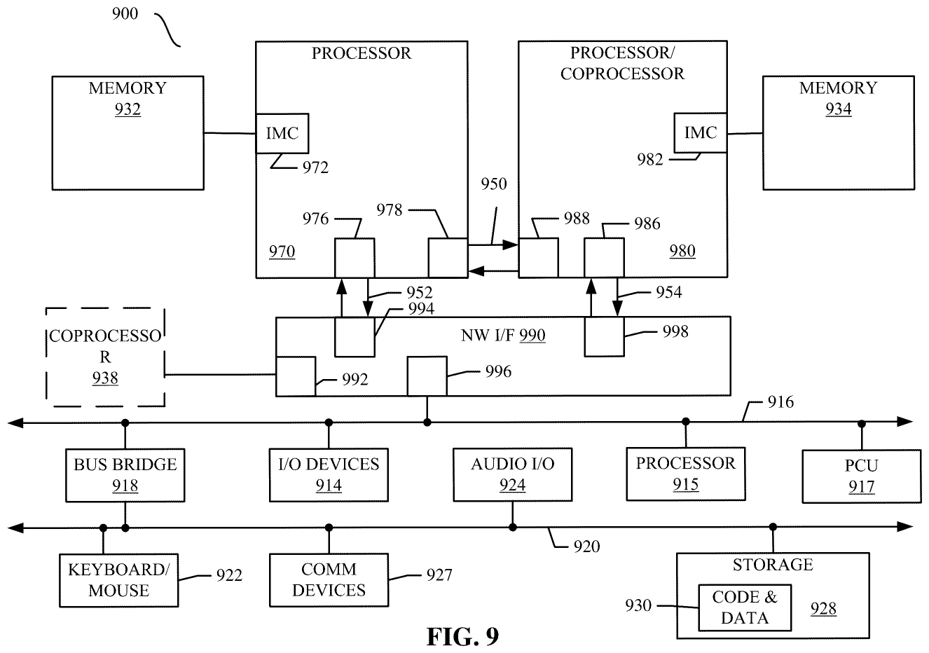

FIG. 9 illustrates an example computing system. Multiprocessor system 900 is an interfaced system and includes a plurality of processors or cores including a first processor 970 and a second processor 980 coupled via an interface 950 such as a point-to-point (P-P) interconnect, a fabric, and/or bus. In some examples, the first processor 970 and the second processor 980 are homogeneous. In some examples, first processor 970 and the second processor 980 are heterogenous. Though the example system 900 is shown to have two processors, the system may have three or more processors, or may be a single processor system. In some examples, the computing system is a system on a chip (SoC).

Processors 970 and 980 are shown including integrated memory controller (IMC) circuitry 972 and 982, respectively. Processor 970 also includes interface circuits 976 and 978; similarly, second processor 980 includes interface circuits 986 and 988. Processors 970, 980 may exchange information via the interface 950 using interface circuits 978, 988. IMCs 972 and 982 couple the processors 970, 980 to respective memories, namely a memory 932 and a memory 934, which may be portions of main memory locally attached to the respective processors.

Processors 970, 980 may each exchange information with a network interface (NW I/F) 990 via individual interfaces 952, 954 using interface circuits 976, 994, 986, 998. The network interface 990 (e.g., one or more of an interconnect, bus, and/or fabric, and in some examples is a chipset) may optionally exchange information with a coprocessor 938 via an interface circuit 992. In some examples, the coprocessor 938 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 970, 980 or outside of both processors, yet connected with the processors via an interface such as P-P interconnect, such that either or both processors' local cache information may be stored in the shared cache if a processor is placed into a low power mode.

Network interface 990 may be coupled to a first interface 916 via interface circuit 996. In some examples, first interface 916 may be an interface such as a Peripheral Component Interconnect (PCI) interconnect, a PCI Express interconnect or another I/O interconnect. In some examples, first interface 916 is coupled to a power control unit (PCU) 917, which may include circuitry, software, and/or firmware to perform power management operations with regard to the processors 970, 980 and/or co-processor 938. PCU 917 provides control information to a voltage regulator (not shown) to cause the voltage regulator to generate the appropriate regulated voltage. PCU 917 also provides control information to control the operating voltage generated. In various examples, PCU 917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 917 is illustrated as being present as logic separate from the processor 970 and/or processor 980. In other cases, PCU 917 may execute on a given one or more of cores (not shown) of processor 970 or 980. In some cases, PCU 917 may be implemented as a microcontroller (dedicated or general-purpose) or other control logic configured to execute its own dedicated power management code, sometimes referred to as P-code. In yet other examples, power management operations to be performed by PCU 917 may be implemented externally to a processor, such as by way of a separate power management integrated circuit (PMIC) or another component external to the processor. In yet other examples, power management operations to be performed by PCU 917 may be implemented within BIOS or other system software.

Various I/O devices 914 may be coupled to first interface 916, along with a bus bridge 918 which couples first interface 916 to a second interface 920. In some examples, one or more additional processor(s) 915, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 916. In some examples, second interface 920 may be a low pin count (LPC) interface. Various devices may be coupled to second interface 920 including, for example, a keyboard and/or mouse 922, communication devices 927 and storage circuitry 928. Storage circuitry 928 may be one or more non-transitory machine-readable storage media as described below, such as a disk drive or other mass storage device which may include instructions/code and data 930 and may implement the storage circuitry 928 in some examples. Further, an audio I/O 924 may be coupled to second interface 920. Note that other architectures than the point-to-point architecture described above are possible. For example, instead of the point-to-point architecture, a system such as multiprocessor system 900 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

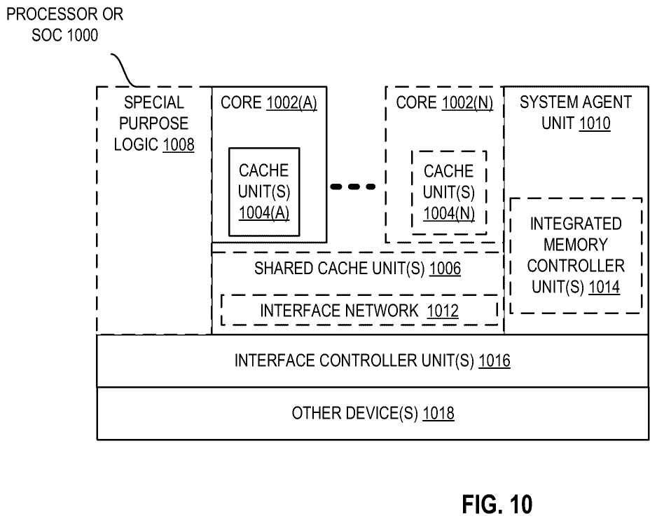

FIG. 10 illustrates a block diagram of an example processor and/or SoC 1000 that may have one or more cores and an integrated memory controller. The solid lined boxes illustrate a processor 1000 with a single core 1002(A), system agent unit circuitry 1010, and a set of one or more interface controller unit(s) circuitry 1016, while the optional addition of the dashed lined boxes illustrates an alternative processor 1000 with multiple cores 1002(A)-(N), a set of one or more integrated memory controller unit(s) circuitry 1014 in the system agent unit circuitry 1010, and special purpose logic 1008, as well as a set of one or more interface controller units circuitry 1016. Note that the processor 1000 may be one of the processors 970 or 980, or co-processor 938 or 915 of FIG. 9.

Thus, different implementations of the processor 1000 may include: 1) a CPU with the special purpose logic 1008 being integrated graphics and/or scientific (throughput) logic (which may include one or more cores, not shown), and the cores 1002(A)-(N) being one or more general purpose cores (e.g., general purpose in-order cores, general purpose out-of-order cores, or a combination of the two); 2) a coprocessor with the cores 1002(A)-(N) being a large number of special purpose cores intended primarily for graphics and/or scientific (throughput); and 3) a coprocessor with the cores 1002(A)-(N) being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1004(A)-(N) within the cores 1002(A)-(N), a set of one or more shared cache unit(s) circuitry 1006, and external memory (not shown) coupled to the set of integrated memory controller unit(s) circuitry 1014. The set of one or more shared cache unit(s) circuitry 1006 may include one or more mid-level caches, such as level 2 (L2), level 3 (L3), level 4 (L4), or other levels of cache, such as a last level cache (LLC), and/or combinations thereof. While in some examples interface network circuitry 1012 (e.g., a ring interconnect) interfaces the special purpose logic 1008 (e.g., integrated graphics logic), the set of shared cache unit(s) circuitry 1006, and the system agent unit circuitry 1010, alternative examples use any number of well-known techniques for interfacing such units. In some examples, coherency is maintained between one or more of the shared cache unit(s) circuitry 1006 and cores 1002(A)-(N). In some examples, interface controller units circuitry 1016 couple the cores 1002 to one or more other devices 1018 such as one or more I/O devices, storage, one or more communication devices (e.g., wireless networking, wired networking, etc.), etc.

In some examples, one or more of the cores 1002(A)-(N) are capable of multi-threading. The system agent unit circuitry 1010 includes those components coordinating and operating cores 1002(A)-(N). The system agent unit circuitry 1010 may include, for example, power control unit (PCU) circuitry and/or display unit circuitry (not shown). The PCU may be or may include logic and components needed for regulating the power state of the cores 1002(A)-(N) and/or the special purpose logic 1008 (e.g., integrated graphics logic). The display unit circuitry is for driving one or more externally connected displays.

The cores 1002(A)-(N) may be homogenous in terms of instruction set architecture (ISA). Alternatively, the cores 1002(A)-(N) may be heterogeneous in terms of ISA; that is, a subset of the cores 1002(A)-(N) may be capable of executing an ISA, while other cores may be capable of executing only a subset of that ISA or another ISA.

The following examples pertain to additional examples of technologies disclosed herein.

Example 1. An example apparatus can include an I/O interface and circuitry. The circuitry can be configured to receive, through the I/O interface, a ciphertext term, the ciphertext term to have a data size larger than a machine word size associated with a multiplier datapath of an accelerator configured to execute an FHE workload associated with the ciphertext term. The circuitry can also be configured to decompose the ciphertext term to a plurality of words such that each word has a data size equal to or smaller than the machine word size. The circuitry can also be configured to cause the plurality of words to be input in the multiplier datapath as separate Montgomery representations in order to compute separate inverse Montgomery representations for each of the plurality of words. The circuitry can also be configured to receive, through the I/O interface, precomputed base conversion factors that were precomputed independent of data included in the ciphertext term, the precomputed base conversion factors to also have been decomposed to have a data size equal to or smaller than the machine word size. The circuitry can also be configured to cause each of the separate inverse Montgomery representations to be multiplied with the precomputed base conversion factors, wherein the multiplication with the precomputed base conversion factors is to convert the separate inverse Montgomery representations from an RNS domain to an RNS/positional number domain.

Example 2. The apparatus of example 1, the FHE workload can include use of a 64K-degree polynomial.

Example 3. The apparatus of example 2, the separate inverse Montgomery representations can be converted to the RNS/positional number domain for use in a relinearization operation associated with the ciphertext term.

Example 4. The apparatus of example 1, the machine word size associated with the multiplier datapath of the accelerator can be 32 bits.

Example 5. The apparatus of example 4, the ciphertext term can have a data size of 128 bits and to decompose the ciphertext term to the plurality of words can include the circuitry to decompose the ciphertext term such that each word has a data size of 32 bits.

Example 6. The apparatus of example 4, the precomputed base conversion factors can be decomposed to have a data size of 32 bits.

Example 7. An example method can include receiving, at an accelerator, a ciphertext term having a data size larger than a machine word size associated with a multiplier datapath of the accelerator. The method can also include decomposing the ciphertext term to a plurality of words such that each word has a data size equal to or smaller than the machine word size. The method can also include inputting the plurality of words in the multiplier datapath, the plurality of words to be input as separate Montgomery representations to compute separate inverse Montgomery representations for each of the plurality of words. The method can also include causing each of the separate inverse Montgomery representations to be multiplied with precomputed base conversion factors that were precomputed independent of data included in the ciphertext term, the precomputed base conversion factors to also have been decomposed to have a data size equal to or smaller than the machine word size, wherein the multiplication with the precomputed base conversion factors is to convert the separate inverse Montgomery representations from an RNS domain to an RNS/positional number domain.

Example 8. The method of example 7, the ciphertext term can be associated with an FHE workload to be executed by the accelerator.

Example 9. The method of example 8, the FHE workload can include use of a 64K-degree polynomial.

Example 10. The method of example 8, the separate inverse Montgomery representations can be converted to the RNS/positional number domain for use in a relinearization operation associated with the ciphertext term.

Example 11. The method of example 7, the machine word size associated with the multiplier datapath of the accelerator can be 32 bits.

Example 12. The method of example 11, the ciphertext term can have a data size of 128 bits and decomposing the ciphertext term to the plurality of words can include decomposing the ciphertext term such that each word has a data size of 32 bits.

Example 13. The method of example 11, the precomputed base conversion factors are decomposed to have a data size of 32 bits.

Example 14. An example at least one machine readable medium can include a plurality of instructions that in response to being executed by a system can cause the system to carry out a method according to any one of claims 7 to 13.

Example 15. An example apparatus can include means for performing the methods of any one of claims 7 to 13.

Example 16. An example system can include a memory, a plurality of compute elements arranged to execute an FHE workload and circuitry resident on a same die or same chip as the memory and the plurality compute elements. The circuitry can be configured to receive a ciphertext term, the ciphertext term to have a data size larger than a machine word size associated with a multiplier datapath through the plurality of compute elements, the ciphertext term associated with the FHE workload. The circuitry can also be configured to decompose the ciphertext term to a plurality of words such that each word has a data size equal to or smaller than the machine word size. The circuitry can also be configured to cause the plurality of words to be input in the multiplier datapath as separate Montgomery representations in order to compute separate inverse Montgomery representations for each of the plurality of words. The circuitry can also be configured to obtain, from the memory, precomputed base conversion factors that were precomputed independent of data included in the ciphertext term, the precomputed base conversion factors to also have been decomposed to have a data size equal to or smaller than the machine word size. The circuitry can also be configured to cause each of the separate inverse Montgomery representations to be multiplied with the precomputed base conversion factors, wherein the multiplication with the precomputed base conversion factors is to convert the separate inverse Montgomery representations from an RNS domain to an RNS/positional number domain.

Example 17. The system of example 16, the FHE workload can include use of a 64K-degree polynomial.

Example 18. The system of example 17, the separate inverse Montgomery representations can be converted to the RNS/positional number domain for use in a relinearization operation associated with the ciphertext term.

Example 19. The system of example 16, the machine word size associated with the multiplier datapath can be 32 bits.

Example 20. The system of example 19, the ciphertext term can have a data size of 128 bits and to decompose the ciphertext term to the plurality of words can include the circuitry to decompose the ciphertext term such that each word has a data size of 32 bits.

Example 21. The system of example 19, wherein the precomputed base conversion factors can be decomposed to have a data size of 32 bits.

Example 22. The system of example 16, the precomputed base conversion factors can be loaded to the memory when the plurality of compute elements are programmed to execute the FHE workload.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

While various examples described herein could use the System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single integrated circuit (“IC”) die, or chip, the present disclosure is not limited in that respect. For example, in various examples of the present disclosure, a device or system could have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
an input/output (I/O) interface; and
circuitry configured to:
receive, through the I/O interface, a ciphertext term, the ciphertext term to have a data size larger than a machine word size associated with a multiplier datapath of an accelerator configured to execute a fully homomorphic encryption (FHE) workload associated with the ciphertext term;
decompose the ciphertext term to a plurality of words such that each word has a data size equal to or smaller than the machine word size;
cause the plurality of words to be input in the multiplier datapath as separate Montgomery representations in order to compute separate inverse Montgomery representations for each of the plurality of words;
receive, through the I/O interface, precomputed base conversion factors that were precomputed independent of data included in the ciphertext term, the precomputed base conversion factors to also have been decomposed to have a data size equal to or smaller than the machine word size; and
cause each of the separate inverse Montgomery representations to be multiplied with the precomputed base conversion factors, wherein the multiplication with the precomputed base conversion factors is to convert the separate inverse Montgomery representations from a residue number system (RNS) domain to an RNS/positional number domain.

2. The apparatus of claim 1, wherein the FHE workload includes use of a 64K-degree polynomial.

3. The apparatus of claim 2, wherein the separate inverse Montgomery representations are converted to the RNS/positional number domain for use in a relinearization operation associated with the ciphertext term.

4. The apparatus of claim 1, wherein the machine word size associated with the multiplier datapath of the accelerator is 32 bits.

5. The apparatus of claim 4, wherein the ciphertext term has a data size of 128 bits and to decompose the ciphertext term to the plurality of words includes the circuitry to decompose the ciphertext term such that each word has a data size of 32 bits.

6. The apparatus of claim 4, wherein the precomputed base conversion factors are decomposed to have a data size of 32 bits.

7. A method comprising:
receiving, at an accelerator, a ciphertext term having a data size larger than a machine word size associated with a multiplier datapath of the accelerator;
decomposing the ciphertext term to a plurality of words such that each word has a data size equal to or smaller than the machine word size;
inputting the plurality of words in the multiplier datapath, the plurality of words to be input as separate Montgomery representations to compute separate inverse Montgomery representations for each of the plurality of words; and
causing each of the separate inverse Montgomery representations to be multiplied with precomputed base conversion factors that were precomputed independent of data included in the ciphertext term, the precomputed base conversion factors to also have been decomposed to have a data size equal to or smaller than the machine word size, wherein the multiplication with the precomputed base conversion factors is to convert the separate inverse Montgomery representations from a residue number system (RNS) domain to an RNS/positional number domain.

8. The method of claim 7, wherein the ciphertext term is associated with a fully homomorphic encryption (FHE) workload to be executed by the accelerator.

9. The method of claim 8, wherein the FHE workload includes use of a 64K-degree polynomial.

10. The method of claim 8, wherein the separate inverse Montgomery representations are converted to the RNS/positional number domain for use in a relinearization operation associated with the ciphertext term.

11. The method of claim 7, wherein the machine word size associated with the multiplier datapath of the accelerator is 32 bits.

12. The method of claim 11, wherein the ciphertext term has a data size of 128 bits and decomposing the ciphertext term to the plurality of words includes decomposing the ciphertext term such that each word has a data size of 32 bits.

13. The method of claim 11, wherein the precomputed base conversion factors are decomposed to have a data size of 32 bits.

14. An system comprising:
a memory;
a plurality of compute elements arranged to execute a fully homomorphic encryption (FHE) workload; and
circuitry resident on a same die or same chip as the memory and the plurality compute elements, the circuitry configured to:
receive a ciphertext term, the ciphertext term to have a data size larger than a machine word size associated with a multiplier datapath through the plurality of compute elements, the ciphertext term associated with the FHE workload;
decompose the ciphertext term to a plurality of words such that each word has a data size equal to or smaller than the machine word size;
cause the plurality of words to be input in the multiplier datapath as separate Montgomery representations in order to compute separate inverse Montgomery representations for each of the plurality of words;
obtain, from the memory, precomputed base conversion factors that were precomputed independent of data included in the ciphertext term, the precomputed base conversion factors to also have been decomposed to have a data size equal to or smaller than the machine word size; and
cause each of the separate inverse Montgomery representations to be multiplied with the precomputed base conversion factors, wherein the multiplication with the precomputed base conversion factors is to convert the separate inverse Montgomery representations from a residue number system (RNS) domain to an RNS/positional number domain.

15. The system of claim 14, wherein the FHE workload includes use of a 64K-degree polynomial.

16. The system of claim 15, wherein the separate inverse Montgomery representations are converted to the RNS/positional number domain for use in a relinearization operation associated with the ciphertext term.

17. The system of claim 14, wherein the machine word size associated with the multiplier datapath is 32 bits.

18. The system of claim 17, wherein the ciphertext term has a data size of 128 bits and to decompose the ciphertext term to the plurality of words includes the circuitry to decompose the ciphertext term such that each word has a data size of 32 bits.

19. The system of claim 17, wherein the precomputed base conversion factors are decomposed to have a data size of 32 bits.

20. The system of claim 14, wherein the precomputed base conversion factors are to be loaded to the memory when the plurality of compute elements are programmed to execute the FHE workload.
